(19) United States
(12) Patent Application Publication
(10) Pub. No.: US 2007/0088713 A1
(43) Pub. Date: Apr. 19, 2007

(54) Method of secure online targeted marketing

(76) Inventors: Arthur Baxter, Chicago, IL (US); Richard John Oszustowicz, Edina, MN (US)

Correspondence Address: EDWIN TARVER, 16830 Ventura Blvd., SUITE 360, Encino, CA, 91436, US

(21) Appl. No.: 11/582,944

(22) Filed: Oct. 16, 2006

Related U.S. Application Data
(60) Provisional application No. 60/726,791, filed on Oct. 14, 2005.

(51) Int. Cl. G06F 17/30

(52) U.S. Cl. 707/10

(57) ABSTRACT

The present invention is a method and system of marketing wherein specific user information in the form of registration and authorization information, personal information, and permitted uses of personal information is used in connection with a secure online environment to enable accurate targeted marketing of specific tailored products and services to specific users. There are three parts of the system of the present invention; a secure storage medium. a secure Internet portal, and Information used in connection with the storage medium and portal to convey online browsing activities to businesses or organizations. The present invention customizes and personalizes the portal by applying customer-selected input. The invention is an environment that trusted merchants can use to track consumer needs. By processing consumer information, this environment updates itself continuously.

### CROSS-REFERENCE TO RELATED APPPLICATION

This is a utility patent application which claims benefit of U.S. Provisional Application No. 60/726,791 filed on Oct. 14, 2005.

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates generally to the field of marketing, and more specifically to targeted marketing on the Internet based on profiles, preferences and market segments of consumers. More particularly, the invention's marketing method collects, manipulates, transmits and packages “data elements” (sometimes referred to as “touchpoints”). Data elements consist of marketing related data regarding the user of the invention. As data elements contain sensitive information belonging to users, the invention maintains the security and privacy of these data elements.

Internet based advertising and target marketing reaches virtually all users of the Internet. Using current technology, the majority of targeted marketing reaches consumers uninterested in the products and services in question. For example, Internet users are commonly exposed to unwanted e-mail or advertisement banners on websites not relevant to their interests or personalized to their needs. Canceling or deleting these messages is time consuming, wastes resources and can be a source of ill will between businesses and consumers.

To streamline online marketing, computer users must be identified and verify that their digital identities match their real-world identities. Digital identity verification techniques seek to link online data with existing “offline” identities to ensure that data corresponds to the appropriate user. This type of verification ensures a secure online experience and enhances the effectiveness of online marketing.

Identity management in the current art focuses on solutions for business and government; including digital certificates, smart cards, PKI, authentication and authorization processes. Consumer identity management includes user certification, but also includes lifecycle management of digital identities. Identity management consists of three types of data; personal, corporate and marketing. This invention applies to all three types of identity management.

Developments in computer technology have improved web services and means of communication. Electronic interactions between computer users and businesses are enabled by infrastructures that facilitate interactions between parties. As a result, businesses need to identify parties in a way that fosters trust, respect for privacy and data protection. In addition, identities management and access affects personal, business, social, and government matters.

Identity management is a necessary component of e-business, and any identity management scheme must be able to verify the digital identity of users and web services to understand, manage and validate their profiles and rights. This is fundamental to ensure accountability in business relationships and enable commercial transactions. Accurate knowledge regarding profiles, preferences and identity information can provide customized and personalized offers that are tailored for added-value services that individual customers or businesses might be willing to pay for. On the other hand, data misuse undermines the effectiveness of the Internet as a marketing tool.

Any effective method for identity verification will necessarily enable Internet commerce businesses to bring ail the parties involved in electronic transactions into a trusting relationship. By verifying the identities of the parties, and the accuracy of the data transferred between them, higher revenue with less effort is possible while engendering respect for the privacy of consumers and keeping their information accurate and secure.

One way marketers accomplish identity verification is through the use of “cookies”; small files or parts of files stored on a user's computer, created and subsequently read by a server, and containing personal information (such as a user identification code, customized preferences, or a record of pages visited).

Since cookies are frequently used indiscriminately by advertisers, computer users are increasingly reluctant to allow them. Unfortunately, since some websites only function properly if a cookie is installed on a user's computer, the user is faced with answering an authorization prompt each time a cookie is encountered. This slows down online activities, hampers efficiency and creates a bad user experience.

To overcome this problem, computer users need a way to automatically discern the difference between cookies that are necessary, such as those used by sites to which a user is a member, and cookies that are unnecessary and unsolicited, which may be used for random blanket marketing and may give away unauthorized identity information. Because of this phenomenon, cookie files, even those from otherwise trustworthy sources, are viewed by users with increasing suspicion, and are routinely disallowed and worst yet deleted. This hampers online marketing efforts made by companies who's products a user might have a genuine interest and need.

Therefore technology that promotes trust between marketers and consumers, preserves accurate consumer data for marketers and targets proper user preferences for marketing materials is necessary. Several methods have been developed in the art for directing specific advertisements to specific viewers. Using these methods, advertisers target users based on information collected from online activities such as interface preferences or information collected by tracking user “surfing” habits or computer IP address. These methods are inefficient in terms of attracting and retaining customers. Regulations and legislative frameworks frequently render customer data unusable, collected customer data seldom reveals accurate market segments, making target marketing difficult, and consumers make information gathering difficult by electing not to share information.

U.S. Pat. No. 6,477,509 to Hammons discloses a method and system for communication and trade on a network, in which information is directed by merchants on the computer screen of a consumer. A lending partner provides the initial capital to offer the consumer an incentive for signing up for the system, and for supplying pertinent information about herself. A management system would integrate the merchant information with consumer information, to send a targeted stream of information to the user. This patent does not provide adequate privacy for consumer data however, and does not separate consumers into different market segments.

U.S. Pat. No. 6,185,541 to Scroggie discloses a system and method for delivering purchasing incentives and a variety of other retail shopping aids through a computer network, such as by E-mail over the Internet. Customers of retail stores can establish a bidirectional communication link with the system, log in to the system, and then elect to browse among available purchasing incentive offers, or elect to explore other shopping aids, such as a shopping list generator, a recipe center, or simply elect to claim a product rebate or to receive product information. This patent focuses on supplying information/incentives to customers based on their inputs over the Internet and does not cover fulfilling customers' requirements in real time.

U.S. Pat. No. 6,141,010 to Hoyle discloses a method and apparatus for providing an automatically upgradeable software application that includes targeted advertising based on demographics and user interaction with a computer. The software application is a graphical user interface that includes a display region used for banner advertising that is downloaded from time to time over a network such as the Internet. The software application is accessible from a server via the Internet and demographic information on the user is acquired by the server and used for determining what banner advertising will be sent to the user. The software application further targets the advertisements in response to normal user interaction, or use, of the computer. This patent concentrates only on targeting advertisements based on user profile and inputs and does not provide any means to ensure that advertisements are being viewed by the targeted audience. Also, this patent does not group users into market segments and aims to serve them individually.

U.S. Pat. No. 6,134,532 Lazarus discloses a system and method for selecting and presenting personally targeted entities such as coupons, products, and information content, based on tracking observed behavior on a user-by-user basis and utilizing an adaptive vector space representation for both information and behavior. This patent only serves users individually and does not group them into market segments. Also, this patent does not provide for privacy of users' information.

Finally, in U.S. Pat. No. 6,622,165 to Philyaw, a method and apparatus for allowing a remote site to interact with an intermediate database to facilitate access to the remote site, and a method for delivering information from a source on a global communication network to a second and a user location thereon is disclosed. A unique code is associated with an advertising action associated with the source location. The unique code is stored in a database and routing information over the global communication network to a defined location on the global communication network for the source associated with the unique code in the database. The unique code is delivered to the user and then accessed of the database by the user results in retrieval of the routing information associated with the delivered unique code by the user. The user is connected to the defined location associated with the delivered unique code in the database and in accordance with the associated routing information retrieved from the database. The associated routing information is changed in the database between the delivered unique code and another defined location on the global communication network in response to commands transferred to the database from the source, such that a later access of the database will cause the accessing user to be routed to another defined location.

This technology enables unauthorized outside parties to access personal information. Furthermore, it lacks an associated web site; and registering the device is a complicated time consuming task involving hard-wired computer connections and the operation of a barcode scanner.

The agreements, standards and technologies that make identity and data entitlements portable across autonomous domains is known as “federated identity.” Federated identity is analogous to a passport, wherein one country provides an individual with a trusted credential that is accepted as proof of his identity by other countries. In the online world, this trust is established through a combination of two technologies that prove identity—strong authentication and access management—and the business and legal agreements that enterprises enter into to establish mutual responsibility and commitment concerning sharing trusted identities. Using this concept, end users can access multiple web and non-web applications and network resources (VPNs for instance), both internal and external to their own organization.

Federated identity management concepts, which are a key component of identity management, enable organizations to share trusted identities across the boundaries of a network with business partners, autonomous business units and remote offices are embodied by the present invention.

The present invention provides an improved method and system to maximize advertiser returns by targeting advertisements to particular customers while reducing marketing and communication costs. Another object of the present invention is to provide a marketing system that provides secure consumer data using only a standard Web browser and a mechanical or flash drive. Another object of the present invention is to increase consumer confidence and control in Internet transactions by preventing misuse of customer profiles, and the unauthorized transmission of customer data. A further object of the present invention is to eliminate the requirement of data refining, and to organize customer information into target market segments while providing a compliance audit trail for advertisements. These and other objects of the present invention will become better understood with reference to the appended Summary, Description, and Claims.

### SUMMARY

The present invention is an improved method and system of marketing, operating under the working title “PrivacyTriggers.” PrivacyTriggers are a brand name for data elements. Again, data elements are marketable facts about the user of the invention. Data elements belong to particular users, and the invention maintains the security and privacy of these data elements while helping users acquire desired products and services.

PrivacyTriggers also help businesses and organizations in three ways; (1) to market goods and services, (2) to ensure customer identity, and (3) to create an audit trail from online activities. By tracking “privacy preferences”, “identity preferences” and “marketing preferences, the system tracks a consumer's interests, needs and wants. When a user performs an action, PrivacyTriggers causes an appropriate response, securing and maintaining the privacy of these communications.

Data security is a key function of the method. For example, personal data security and privacy is particularly important in investment or healthcare applications of the invention. The invention also allows the user to share and transmit data elements. The data elements recipient is the user's chosen marketer or service provider. In this case, data element transmission becomes a part of opt-in marketing. With this invention, users can opt in or opt out of membership marketing programs and marketers can use the data elements to send targeted marketing messages. Using the method in a healthcare context, opt-in service can be. procured; for example, a user might wish to procure therapy services.

PrivacyTriggers enables organizations to perform real-time, two factor user authentication to engender a trust among online users. PrivacyTriggers integrates with two other identity verification technologies; specifically, a portable memory device (referred to as a “BuddyDrive”) that redirects and secures cached information, and a secure web portal/interface/database (referred to as the “BuddyPassport”), associated with the sponsor, merchant or manufacturer of the memory device, which ensures user data accuracy and security. The combination of BuddyDrive and BuddyPassport protect data that is stationary and data that is in motion. BuddyDrive protects mobile data by serving as a portable, password-protected, miniature database. BuddyPassport protects stationary data by encrypting data transmissions between Internet databases.

Although the BuddyDrive can take many forms, it is essentially a substantial hardware memory capsule. This memory capsule includes BuddyDrive software for storage, identity authentication, security, data transmission and reception, and other purposes. BuddyDrive also includes a BuddyPassport client and interface. Both at a user level and at an expert sponsor level, this client software is configurable. Vendors may alter the software for use with a particular product or sponsor, and products incorporating BuddyDrive technology can be a phone, smartcard or a mechanical device.

PrivacyTriggers operates when a user plugs a BuddyDrive into a computer and accesses the BuddyPassport site. A two-factor authentication system consisting of a password and a unique device identifier (UDI) identifies the user. Once a secure connection has been made, a user permits PrivacyTrigger data to be transmitted to the sponsor/merchant of the BuddyDrive and any organizational partners.

One particular use of the system is in the healthcare industry. IN this version, the BuddyDrive comprises a portable Personal Health Record (PHR) storage system. It is a miniature, personal, secure data warehouse. In emergency care situations, the BuddyDrive can instantly transfer a patient's medical history to an emergency room.

A patient's spouse can use a BuddyDrive to send data to a hospital before a visit. BuddyDrive software can send patient information to a trusted medical site by Internet, facsimile or other means. This site could be the emergency room, doctor's office or hospital. If the information travels by Internet, then the BuddyPassport secure Internet portal is the preferred route.

After the emergency room visit, the BuddyDrive can access a HIPPA-approved record of the visit. This record contains a price, cost and cash analysis of rendered services, medications, prognosis and recommendations.

The BuddyDrive device contains the analysis of the emergency room procedure. (The same holds for hospitalization, therapy sessions or doctor office visits.)

At this point, a “3PM system” comes into play. A 3PM system is our term for a portable, private medical and healthcare system. Because of the emergency room records, the BuddyDrive and 3PM system connect the emergency room into the data warehouse. The BuddyDrive and 3PM system is the first invention to make this critical connection. At last, medical histories will include vital data that would otherwise never appear.

PrivacyTriggers in this context refers to names applied to consumer personal data, and the system by which a user chooses what information may be reliably and securely transmitted to an organization.

During the initial authentication process, users permit one or more PrivacyTriggers to be shared with organizations through a selection process. The software of the BuddyDrive and BuddyPassport use these individually selected PrivacyTriggers as switches, enabling or disabling BuddyPassport features, and customizing the web portal to fit individual user needs.

After the initial authentication process, the BuddyPassport interprets PrivacyTrigger data to organize user information in the context of the services of an organization. For instance, if a user selects PrivacyTriggers related to their medical history, diet or personal health issues, the BuddyPassport allows health industry organizations to provide relevant information. In another context, if a user selects purchase histories, purchase plans, or credit history; marketers would be able to target the consumer.

In addition to selecting the information made available to organizations associated with the BuddyPassport, PrivacyTriggers also govern how information is disseminated using the same selection process. User authentication is required before BuddyPassport access is granted, and PrivacyTrigger access is governed by individual consumers using the BuddyDrive. PrivacyTriggers allow consumers to regulate the information they receive and how they receive it, while ensuring that organizations reach the right users.

This system also allows users to remain anonymous while permitting an organization to know that user is a part of a predefined class. The organization will also know when a BuddyDrive UDI becomes active, and knows when a user is able to receive information.

From marketers, two-level authentication makes PrivacyTriggers an ideal opt-in program. Using this method, consumers offer their permission to securely mine accurate data on a variety of topics, generating marketing opportunities. In this manner, PrivacyTriggers obviates the requirement for data warehouse scrubbing, delivers instant access to sales leads, verifies a level of interest in targeted subjects, and overall, establishes reliable trusting relationships between consumers and marketers.

PrivacyTriggers, as interpreted through the BuddyDrive and BuddyPassport facilitates data collection on consumers. PrivacyTriggers selected by a consumer presents a clear, complete, secure, and user-authorized picture of the consumer by increasing the efficiency of a marketer's data gathering efforts. Marketers' enterprise resource planning (ERP) applications can readily process the harvested data.

PrivacyTriggers information is communicated by consumers to the BuddyPassport portal in three stages. In the first stage, customers provide contact data such as name, address, phone number, and email address. It is anticipated that to take advantage of the privacy and cache redirecting aspects of the BuddyDrive, the customer must provide at least one of item of requested data. The BuddyDrive operates as an incentive in this process.

The BuddyDrive is a portable storage device, containing proprietary software, which protects personal privacy by redirecting cached data generated due to browsing, such as history, cookies, favorites, emails, and passwords, from a computer onto the BuddyDrive, thereby preventing private information from being collected from the computer. BuddyDrive technology can also reside in a stand-alone device, such as a mobile phone or fax-phone.

The second stage establishes the various types of information that may be regulated through the PrivacyTriggers system. During this stage, a user selects various PrivacyTriggers that may be accessed by marketers, for instance; medical history, diet and personal health issues; net worth, investment portfolio and credit history; or purchase history, purchase plan and credit history information. Again, to participate in BuddyPassport privileges, it is anticipated that a consumer must provide at least one PrivacyTrigger data item.

In the third stage, consumers use the PrivacyTrigger selection process to authorize marketers to use PrivacyTriggers for particular purposes, such as through third party business research, direct mail, or email marketing. Consumers are required to complete this step to ensure the proper functioning of the PrivacyTriggers system.

Once PrivacyTriggers have been established, a consumer may use the BuddyDrive to access the Internet through the BuddyPassport and be assured a secure online session, while permitting trusted marketers to see reliable relevant information about consumer browsing habits.

Besides its memory capabilities, a BuddyDrive can store and run software. This hardware needs no installation on the host computing device. Instead, the software runs from the BuddyDrive device. A BuddyDrive can also serve as a private, secure and password-protected client for a remote Internet server. Physically, a BuddyDrive may take many forms; including a memory stick, smart card, or even a mobile phone. The BuddyDrive need not be an entire product unto itself. A manufacturer can incorporate BuddyDrive technology as a licensed part of another product. For example, the manufacturer could build BuddyDrive capabilities into many types of products; music players, set-top boxes, laptop computers or even automobile dashboards.

Medical history communication presents a special case, and adds a fourth tie-in stage in the process. BuddyDrive ties emergency room records into the patient's medical history. Emergency rooms emphasize immediate care. Often, emergency care workers are contractors. Clerks may never transcribe paper records of emergency room visits into the central data warehouse. The patient's primary care physician might never know about the patient's emergency care. The BuddyDrive securely stores a price, cost and cash analysis of such care. A private copy of this analysis transfers to the central data warehouse. With BuddyDrive, the hospital, physician and healthcare provider are all on the same page.

As various changes could be made in the above described embodiments without departing from the scope of the invention, it is intended that all the matter contained in the above description should be interpreted as illustrative and not in the limiting sense. For example, the present invention can be utilized in other contexts such as in-house corporate departments or clubbed with other marketing schemes without departing from the spirit or intent of the invention.

To accomplish the foregoing and related ends, the invention comprises the features hereinafter fully described. The following description and the annexed drawings set forth in detail certain illustrative embodiments of the invention. These embodiments are indicative, however, of but a few of the various ways in which the principles of the invention may be employed.

### BRIEF DESCRIPTION OF DRAWINGS

FIG. 1 is a schematic diagram depicting the utilization of PrivacyTriggers of the present invention.

FIG. 2 is a chronological diagram depicting three tiers of PrivacyTriggers that may be provided by customers.

FIG. 3 is an illustration demonstrating the gap between recommended appropriate care and delivered medical care, by certain medical conditions

FIG. 4 is the approximate number of in-hospital deaths from medical error vs. other major causes of death in the United States

FIG. 5 is a map of the Healthcare embodiment of the System

### DESCRIPTION

The present invention is a method and system of communicating information, referred to herein as “PrivacyTriggers.” PrivacyTriggers works with a portable information storage medium and interface (device), referred to herein as a “BuddyDrive. This device could be a phone,smartcard or mechanical device. The storage medium may be connected to and removed from a computer. In phone case, the phone may be either a computer-dependent phone or a standalone phone. Such a standalone phone might be a mobile device requiring no separate computer. When operating though a BuddyDrive, PrivacyTriggers use the BuddyDrive as a Web client for a particular Web portal, referred to herein as the “BuddyPassport.” The client aspect is one of BuddyDrive's interfacing capabilities. Both the Web portal and BuddyDrive contain databases. The combination of BuddyDrive and BuddyPassport protect data that is stationary and data that is in motion.

The BuddyDrive functions to direct all cached information from an Internet browsing session onto the device. Using a two-factor authentication system consisting of a unique device identifier (UDI) and password, BuddyDrive permits Internet access through BuddyPassport, a specialized portal. BuddyPassport allows Internet surfing activities in security, and users connect to trusted organizations.

PrivacyTriggers are user-selected, personal marketing information that the user permits an organization to view. After an initial authentication session, PrivacyTriggers govern the user data an organization may use, and how the data may be used. Since the data has been authenticated, it can bypass data refining requirements which are currently necessary, and organizations can take reach new users in the system, accurately gauging user data in relation to actual users.

The BuddyDrive is a portable storage device, containing proprietary software that protects user information by redirecting cached data generated during online computer activities; such as URL history, cookies, favorites, emails, and passwords, onto the device.

The BuddyPassport is a web portal associated with an organization, frequently, a sponsor of the BuddyDrive. The BuddyPassport portal is divided into segments containing utility applications and advertisements.

The PrivacyTriggers are verified in combination with the individual BuddyDrive used, and the personal data a user has selected for sharing. PrivacyTriggers also refers to the specific user data, or “touchpoints” being transmitted when some amount of data is selected by a user and shared between one or more organizations. When the user performs an act, PrivacyTriggers cause the system to respond appropriately. PrivacyTriggers also keep the user-to-organization communication channel private and secure.

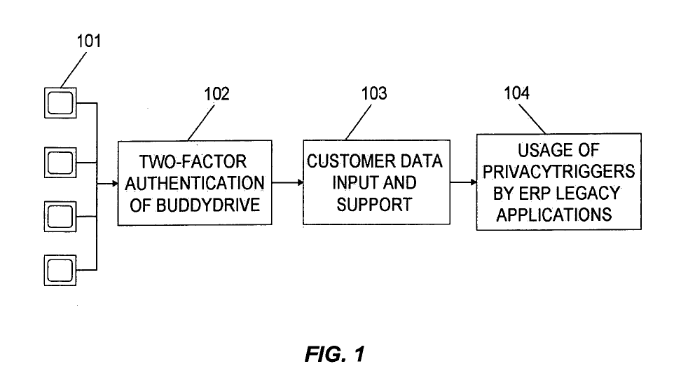

FIG. 1 is a schematic diagram depicting the utilization of PrivacyTriggers of the present invention. The figure shows the stages of Customers using computers 101, Two-Factor Authentication of BuddyDrive 102, Customer Data Input and Support 103, and Usage of PrivacyTriggers by ERP Legacy Applications 104.

In the first stage 101, Customers use computers at different places such as Home, Work, School, or Entertainment locations. These consumers plug the BuddyDrives to computers and start using them.

In the second stage 102, when a user provides the password for a BuddyDrive, the device is authenticated. Thereafter, authentication is automatic, and occurs when the device transmits its unique device identifier (UDI) during use. The UDI allows BuddyPassport to associate settings with a particular BuddyDrive device. Although the customer remains anonymous, the UDI makes the association possible. This association streamlines the identification process by eliminating manual re-authentication.

In the third stage 103, the organization requires authentication before BuddyPassport access is permitted. During the authentication step, a user grants permission to the organization for the use of particular PrivacyTriggers. By offering PrivacyTriggers to the organization, users create their own privacy policy, protected by the BuddyDrive. Authentication proceeds online in real time.

Through PrivacyTriggers, a user can grant or deny information to organizations. By granting a PrivacyTrigger, a user declares interest in an organization, and their products and services. As PrivacyTriggers are used through the BuddyPassport, the value of the BuddyDrive increases to its user. The BuddyPassport software uses PrivacyTriggers as switches. These switches enable or disable BuddyPassport features, customizing the portal to the preferences of an individual user in real-time, and providing dynamic policy updates regarding the user.

From an organization's perspective, authentication makes BuddyPassport an opt-in marketing program. Users offer their permission to participate. For that reason, the program bypasses data warehouse refining requirements. In a marketing context, BuddyPassport instantly delivers access to bona fide sales leads and customer data.

Some information, such as a user's social security number, always remains confidential. Transmission of this sensitive information requires customer permission. One situation where this information might be transmitted is in a healthcare relationship. In an emergency room, access to BuddyDrive's personal history records (PHR) is private. A challenge-management system protects BuddyDrive from unauthorized access and hacking. The BuddyDrive is also a password-protected device. Emergency access requires a driver's license or answer to a challenge question. The user might define other means. The user could also designate the level of data access. For instance, the driver's license entry mode could permits access to an abstract. This medical abstract could include next-of-kin, allergies and general history. Or the driver's license could permit access to the entire database.

BuddyDrive stores contingent decision maker contact information, such as next of kin, appointed person with power of attorney, doctor, health insurer, etc. For an incapacitated user, these contacts can provide approval for records access, payment and treatment. BuddyDrive's challenge-management system resists unauthorized use of backdoor emergency access. K knowing that they control access to their social security numbers, improves patient confidence.

After authentication, the BuddyPassport portal opens, connecting the customer to the organization's site. BuddyPassport provides an environment that naturally enhances two way CRM and e-commerce. An organization can learn about the user's interests, dislikes, needs, market behavior, market segment, finances, or may receive a direct sales request. Over time, each communication between the customer and marketer personalizes the Buddy Passport, increasing the reliability of targeted marketing.

The BuddyDrive and the BuddyPassport portal form a closed loop system, which eliminates problems associated with information thieves and online competitors alike. A proxy server, VPN, and SSL protect the consumer from marketers and hackers outside the BuddyPassport portal. Through customer relationship management (CRM), this system also improves, promotes, and accelerates the buying cycle.

The BuddyPassport represents an organization and associated groups to interested users. This interface function acts as a matchmaker of sorts. It allows a business to tailor online marketing communication to a consumer's needs, including minute profile details and changing buying habits over time. This unique ability keeps the marketer/consumer relationship both personal and exclusive. For the marketer, the BuddyPassport functions as a representative. The BuddyPassport portal allows specific messages to be aimed directly to a specific and more responsive group of consumers.

The fourth stage 104 represents the use of PrivacyTriggers by ERP Legacy Applications. BuddyPassport provides a single location for all incoming data regarding a user. For merchants, the BuddyPassport database becomes a customer information clearinghouse. This clearinghouse leverages the data collection abilities of the merchant's servers and mainframe.

Through the use of PrivacyTriggers, the BuddyPassport database projects a clear, complete, secure, and customer-authorized picture of the user. The BuddyPassport database increases the efficiency and power of the marketer's data gathering efforts, and Enterprise Resource Planning (ERP) or corporate backend applications can easily process this new data.

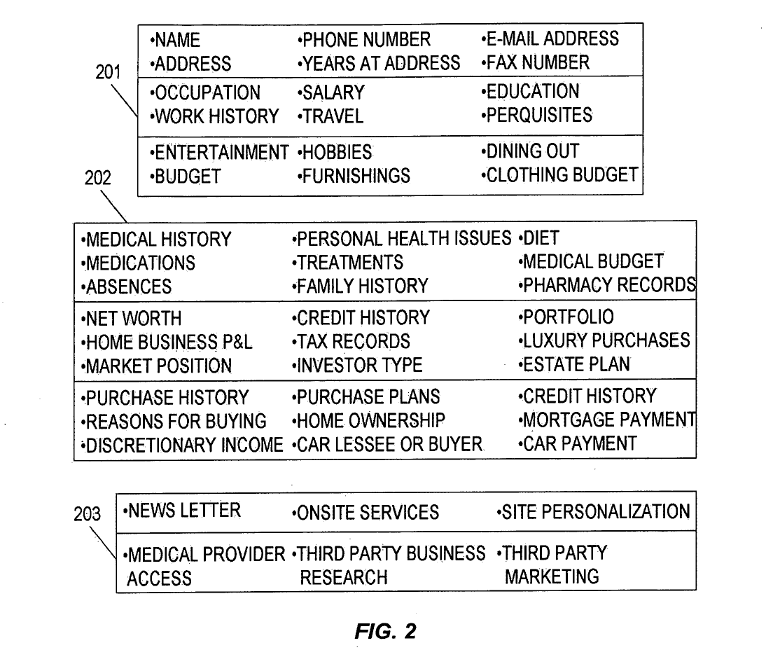

FIG. 2 is a chronological diagram depicting three tiers of PrivacyTriggers that may be provided by customers to the BuddyPassport portal. The three tiers are Contact Data Tier 201, Sensitive Data Tier 202, and Authorization Tier 203. At the heart of the marketing solution of the present invention is identity-based authentication with PrivacyTriggers. The following authentication walkthrough highlights the use of tiers and icons to delineate each step.

Contact Data Tier 201: This tier involves personal contact information such as phone numbers, and other basic consumer data. Although a customer may elect to share or withhold this information, to take advantage of the BuddyDrive's information caching capabilities, it is anticipated that the customer must select at least some personal contact information, if only for authorization purposes.

Sensitive Data Tier 202: This tier consists of information that is related to some area of a typical online browsing session. This information consists of more sensitive information such as medical and heath data, financial information, and commercial data involving shopping records. A user elects to share or withhold such information. However, it is anticipated that to participate in BuddyPassport privileges, the user must select one or more of these PrivacyTriggers.

Authorization Tier 203: This tier arrangement is different from the arrangement of previous tiers. The customer has already chosen in the previous tiers, which PrivacyTriggers the marketer can use. Here, the customer authorizes the marketer to use PrivacyTriggers for particular purposes such as third party business research. This tier addresses how the information selected in tier two may be used. Again, it is anticipated that to participate in BuddyPassport privileges, the customer must select at least one PrivacyTrigger from this tier.

It is anticipated that PrivacyTriggers may become a part of an email spam filter system that the BuddyPassport offers. The spam filter would only pass messages from authorized users or PrivacyTrigger supported accounts. The rest of the messages would land in the user's spam folder. In this situation, the pass key would be a 128-bit encrypted number to prevent unauthorized users from gaining access via a common word key. Multiple users of the same PrivacyTrigger would need two different, possibly autogenerated numbers created by a common, seeded, pseudo-random number generator. One manner of accomplishing this dynamic numbering is to have a sponsor server transfer a number to the BuddyPassport server by a separate encrypted channel. If the code-channel and email-channel numbers match, the message will pass.

This same passkey technique may be employed with regard to the Internet in general. In this instance, a pop-up would need to submit a PrivacyTrigger number to a PrivacyTrigger-enabled browser to download and display an HTML file. Such files may be stored on the BuddyDrive as temp files. Then the local PC displays the message. Without a match, however, the message won't display. By blocking non-matching messages from storage, the PrivacyTriggers of the present invention also function as a filtering tool.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

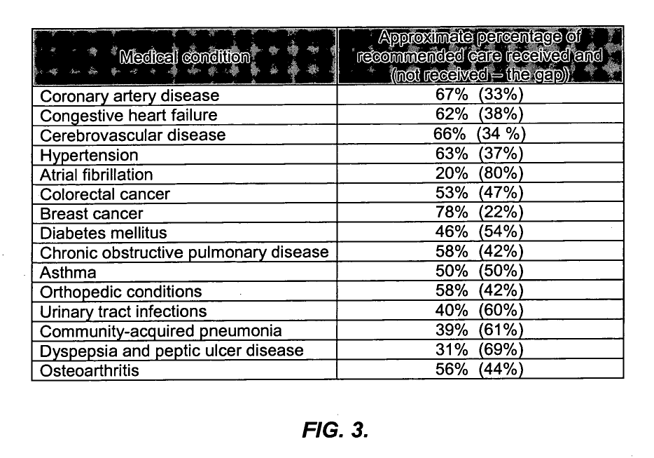

FIG. 3 applies the BuddyDrive, PrivacyTriggers and 3PM system to a healthcare business case. After an emergency room visit, BuddyDrive includes a data summary such as FIG. 3. This data summary complies with federal regulations such as HIPAA, Medicare, Medicaid and the FDA impose.

The member user's summary includes a price, cost and cash analysis of the visit. This analysis becomes part of the member user's 3PM database. The 3PM system generates such information for each visit, procedure or like transaction.

For other uses of the BuddyDrive and 3PM system, the same analysis and occurs. Each member user and practitioner meeting generates a cost, price and cash data breakout. The data breakout adheres to all PrivacyTriggers strictures. This breakout captures detail price, cost and out-of-pocket cash information. The information covers every line item on every medical bill.

For the medical case, PrivacyTriggers are private and secure. As the member user designates, these PrivacyTriggers may contain personalized marketing data or depersonalized marketing data. Again, in either case, the data is private and secure. Privacy and security covers the mainframe, the servers, and the personal and mobile BuddyDrive device.

With the data available to the customer, the customer may make informed a cost/benefit analysis of his medical services.

Most emergency room treatments aren't a part of a patient's primary care regimen. Especially remote emergency service might not appear on the primary care database. BuddyDrive and 3PM tie emergency room treatments into the larger healthcare system. With BuddyDrive and 3PM, the primary care physician now enters the loop. The physician can now make informed choices about the patient's continuing care. At last, the patient's own doctor, will have the patient's complete history. The same applies to the patient's attending medical practice and the associated hospital.

Hospital medical services auditors may access non-personal treatment data. The 3PM data system makes such data available. PrivacyTriggers keeps private data separate and secure. The availability of the remaining data will ease and facilitate the collection and analysis process. For example, the hospital might assess the cost of in-house pharmacy treatments, or the duration of CAT scans.

The hospital is both a marketer and a procurer of goods and services. Data from the 3PM data warehouse includes both personal and impersonal marketing information. Such data would be immensely valuable to both marketers and purchasing agents. This patient treatment data continuously updates. The data is timely. It is also very detailed. The data source is already on the mainframe. The customer has already qualified what the marketer can use, and what is off limits. In either case, data access is immediate.

Using PrivacyTriggers, BuddyPassport allows for instant, personalized marketing programs. The marketer sets up the program through his own server. BuddyPassport triggers the program to the patient. For example, a hospital's outreach program could market a therapy gym to a hip replacement patient. If the patient's primary care physician recommends this therapy program, Medicare might pay for it. Depending on patient data, the system adjusts the price, location and type of care. The system also reminds the patient to attend. The patient responds by recording her visits. The HIPPA nurse at the therapy gym tracks progress. BuddyDrive securely stores all these records. A private copy resides on the healthcare mainframe.

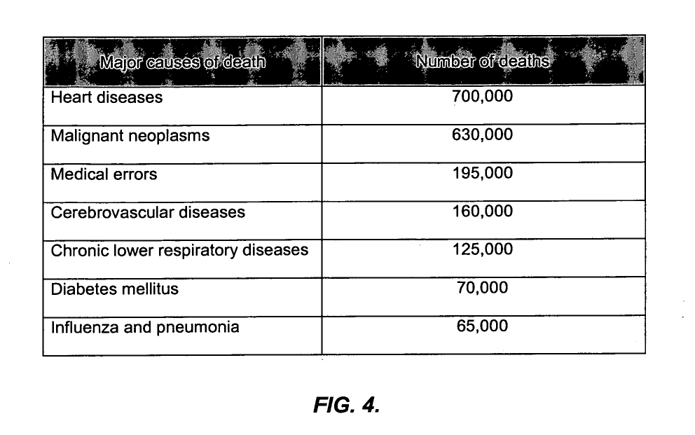

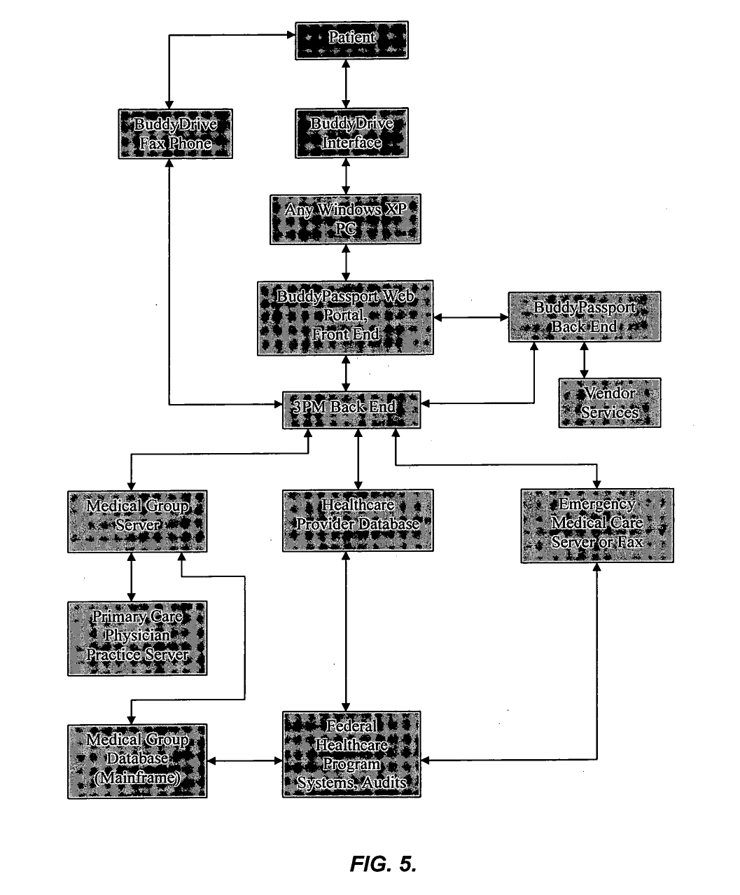

FIGS. 4 and 5 apply to the healthcare application of the BuddyDrive system. These figures provide background data that should help in assessing the need for a means of chronic illness management.

FIG. 4 indicates the gap between recommended and delivered medical care. The BuddyDrive system can help to reduce this critical gap. BuddyDrive allows a medical care system to remind a patient to undertake and continue his treatment program. BuddyDrive can also empower the patient. With BuddyDrive, the patient receives an analysis of medical care costs, prices and cash outlays. This analysis helps the patient to manage procurement of superior healthcare programs, medications, treatments and providers. The two-way communication feature also helps the medical system to inform the patient of appropriate treatments.

FIG. 5 is a table that expresses the number of deaths from medical errors. One way to reduce these terrible figures is by increasing the flow of two-way medical information. BuddyDrive provides a private, secure means to store and disseminate a medical history. The user controls the distribution of this data. Through BuddyDrive, the practice, hospital, emergency room and provider can communicate with the user. Use of BuddyDrive conveys opt-in and opt-out privileges that the user controls. In return, medical service providers that the user approves may access user-selected PrivacyTriggers. The benefits of this two-way data flow improve the patient's chance of superior, reliable and proper treatment. With this superior treatment, the hospital reduces its liability risk. The care provider reduces its costs while adding and retaining customers.

FIG. 6 is a map of the entire BuddyDrive system. Note that the user gains two-way access to the system by two methods . . . .

A. A telephone.

B. A BuddyDrive that connects to a PC.

The telephone could be a mobile phone, wired phone or VoIP phone. The phone includes BuddyDrive software, but operates under its own computing power. That is, the phone doesn't require connection to a personal computer. Through the 3PM back end system, this phone can access an emergency room. The phone can upload to the emergency room personal medical records from the internal BuddyDrive. The phone can also fax records to an emergency that operates on a paper basis. Such dual access to an emergency room allows the BuddyDrive to access emergency services that don't have computers.

Through the 3PM system, the BuddyDrive system maintains a record of what the emergency room received. The patient may add further details of the visit.

The 3PM system transmits this emergency room record to the user's healthcare provider and medical group servers. In most medical care systems, these systems have no assured link. For the first time, the 3PM system brings the emergency room into the loop. At last, the user's primary care doctor will receive crucial treatment data. This data might well prevent improper treatment. At the least, the information will keep the history current and improve the doctor's care.

During audits, BuddyDrive use also helps practices, providers, hospitals and emergency rooms. During healthcare audits, added BuddyDrive history records render medical databases more accurate.

What is claimed is:

1. A method of improving online targeted marketing based on customers' preferences, comprising the steps of:
(a) providing a selection process via a web portal for a user to select a data for transmission;
(b) automatically selecting one or more persons or entities from among a predefined set of persons or entities based on the contents of the data;
(c) allowing the one or more persons or entities access to the data; and
(d) according to predefined parameters, selectively allowing the one or more persons or entities to send data back to a user.

2. The method of claim 1, wherein the data comprises information about a user of the method.

3. The method of claim 2, wherein the data comprises information generated during online activities.

4. The method of claim 3, wherein the data comprises information regarding the identity and preferences of the user of the method.

5. The method of claim 4, wherein the data comprises information relevant to marketers and other entities seeking to sell goods and services to the user of the method.

6. The method of claim 1, wherein each persons or entities from among a predefined set of persons or entities may only see a part of the information contained in the data, according to predetermined criteria.

7. The method of claim 1, wherein the data corresponds to only one person or entity using the method.

8. The method of claim 1, wherein the user governs the data that can be seen by the predefined set of persons or entities.

9. The method of claim 1, wherein the data is selected by a user and comprises:
(a) contact data such as name, address, phone number, email, etc;
(b) data related to the thematic elements of browsed web pages; and
(c) selection of the type of data allowed to be delivered to a user.

10. The method of claim 9, wherein the user is required to select at least one item of data.

11. The method of claim 9, wherein the user is required to select at least one data item during a browsing session.

12. The method of claim 9, wherein the user is required to select at least one type of data from a choice provided by the one or more persons or entities from among a predefined set of persons or entities.

13. The method of claim 1, wherein the system gathers, stores and organizes anonymous data.

14. The method of claim 1, wherein the system separates anonymous data from user data.

15. The method of claim 1, wherein the data is transmitted through a secure web interface.

16. The method of claim one, wherein the data is transmitted through a secure web interface.

17. The method of claim 1, wherein the data is stored in a storage medium

18. The method of claim 17, wherein the data is stored in an individually identifiable storage medium.

19. The method of claim 17, wherein the data is stored in an individually identifiable storage medium controlled by a single user.

20. The method of claim 17, wherein the storage medium is authenticated upon first use.

21. The method of claim 17, wherein the authentication comprises entry of initial data by a user, followed by automatic transfer of a unique device identifier to the memory device.

22. The method of claim 21, wherein the authentication initial data comprises a password, or challenge question.

23. The method of claim 17, wherein the portable memory device:
(a) contains proprietary software applications;
(b) is capable of being plugged to a computer system; and
(c) redirects and stores all cached data from an Internet browsing session

24. The method of claim 17, wherein the portable memory device comprises a phone, smart card or mechanical device.

25. The method of claim 17, wherein the method comprises an authentication/authorization system for accessing a secure web portal after plugging the memory device to a computer system.

26. The method of claim 17, wherein the memory device contains the user's medical history, including emergency room visits.

27. The method of claim 26, wherein the memory device can provide, receive, update, transmit and manage personal health record (PHR) information.

28. The method of claim 26, wherein a nurse initiates a medical account for the member user of the device.

29. The method of claim 28, wherein during a patient interview, the nurse inputs the user's health data.

30. The method of claim 28, wherein during a patient interview, the nurse uploads the user's complete medical history to the device.

31. The method of claim 17, wherein the memory device can transmit patient health related (PHR) information via the Internet, facsimile or other means.

32. The method of claim 17 wherein the data transmitted between user patient and doctor, emergency room, hospital or healthcare provider is secure.

33. The method of claim 32, wherein a contingency is arranged wherein, in an emergency, the user permits a trusted representative to make the data transfer.

34. The method of claim 26, wherein a user can elect to allow a specially-equipped emergency room to receive data from an RFID transponder.

35. The method of claim 34, wherein the both the memory device and medical facility would have miniature transceivers.

36. The method of claim 35, wherein the transceivers operate on RFID technology.

37. The method of claim 26, wherein the information from the device is sent ahead of the user in an emergency setting.

38. The method of claim 17, wherein the user plugs in the memory device when browsing to permit target marketers to see reliable relevant information about the user's browsing habits.

39. The method of claim 1, wherein the authentication proceeds in real time.

40. The method of claim 1, wherein the software configuring the web portal uses the data as switches that enable or disable features of the web portal, thereby customizing the web portal based on the user's selections.

41. The method of claim 10, wherein the customization of the web portal takes place in real time.
